(19) United States
(12) Patent Application Publication
(10) Pub. No.: US 2026/0001478 A1
(43) Pub. Date: Jan. 1, 2026

(54) U-TURN SIGNAL INDICATION SYSTEM

(71) Applicants: Noel Mendoza, Orlando, FL (US); David Mendoza, Kennesaw, GA (US); Eliel Mendoza, Kirkland, WA (US)

(72) Inventors: Noel Mendoza, Orlando, FL (US); David Mendoza, Kennesaw, GA (US); Eliel Mendoza, Kirkland, WA (US)

(21) Appl. No.: 19/243,068

(22) Filed: Jun. 19, 2025

Related U.S. Application Data
(60) Provisional application No. 63/664,635, filed on Jun. 26, 2024.

(51) Int. Cl. B60Q 1/34; B60Q 1/00; B60R 16/023

(52) U.S. Cl. CPC B60Q 1/343; B60Q 1/0094; B60R 16/023

(57) ABSTRACT

A U-Turn signal indicating system includes a controller that connected to a vehicle by a communication plug and is selectively operated by a vehicle component alone or in conjunction with a user input device. The controller is nested within a main body housing and includes a processor, a memory, and power unit. The vehicle communication plug includes a CAN transceiver for communicating with the CAN bus of a motor vehicle. The plug allows the controller to send and receive information with the vehicle's onboard computers that operate the turn signal indicator lights. The controller detects vehicle settings or actions performed by the driver alone or in combination with the actuation of the user input device and instructs the vehicle computer to operate the turn signal lights in a specific pattern that is provided to the vehicle by the controller.

### CROSS-REFERENCE TO RELATED APPLICATIONS

This application claims the benefit of U.S. Application Ser. No. 63/664,635 filed on Jun. 26, 2024, the contents of which are incorporated herein by reference.

### TECHNICAL FIELD

The present invention relates generally to the automotive industry, and more particularly to a U-Turn signal indication system.

### BACKGROUND

The statements in this section merely provide background information related to the present disclosure and may not constitute prior art.

Turn signal indicator lights are installed in virtually all motor vehicles. The lights are positioned on both sides of the vehicle and are used to indicate the vehicle intends to make a turn in the direction for which the signal light is active.

As shown at Background FIG. 1, the most commonly utilized visual pattern for turn signal lights is a sequence of repeating step pulses with equal time allocation between an active light signal (on) and an inactive light signal (off). In most instances, each of the step pulses lasts about 1 second, whereby the turn signal lights of the vehicle are on for 0.5 seconds and off for 0.5 seconds. This pattern repeats itself continuously until the driver adjusts the turn signal control lever or the vehicle makes the turn and automatically resets the turn signal control lever within the vehicle.

Although extremely useful and beneficial when making standard left or right hand turns, it is a common occurrence for vehicles waiting at an intersection, or at a road turning point, to make a U-turn instead of a left turn. Unfortunately, the currently implemented design standard for automotive turn signals does not differentiate between a left turn and a U-turn thus potentially causing an accident when vehicles at a shared intersection, or opposite traffic road, need to react to an unexpected U-turn instead of the assumed left turn.

Accordingly, it would be beneficial to provide a U-turn indication system that can communicate with a vehicle's integrated systems to generate a new visual lighting pattern to indicate the vehicle intends to make a U-turn, thus overcoming the drawbacks noted above.

### SUMMARY OF THE INVENTION

The present invention is directed to a U-Turn signal indicating system. One embodiment of the present invention can include a controller that is connected to a vehicle communication plug and a user input device. The controller can be nested within a main body and can include a processor, a memory, and power unit.

In one embodiment, the vehicle communication plug can include a CAN transceiver for communicating with the CAN bus of a motor vehicle. The plug can allow the controller to send and receive information with the vehicle's onboard computer(s) that operate the turn signal indicator lights. The controller can detect vehicle settings or actions performed by the driver and can instruct the vehicle computer to operate the turn signal lights in accordance with a specific pattern that is provided to the vehicle by the controller.

The user input device can include a physical button that can be actuated by a driver alone, or in combination with other vehicle components such as the turn signal stalk to instruct the controller to send the command to the vehicle to operate the turn signal indicator lights in the specific pattern.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a graph illustrating the turn signal waveform performed by the turn signal indicator lights of a motor vehicle, in accordance with background art.

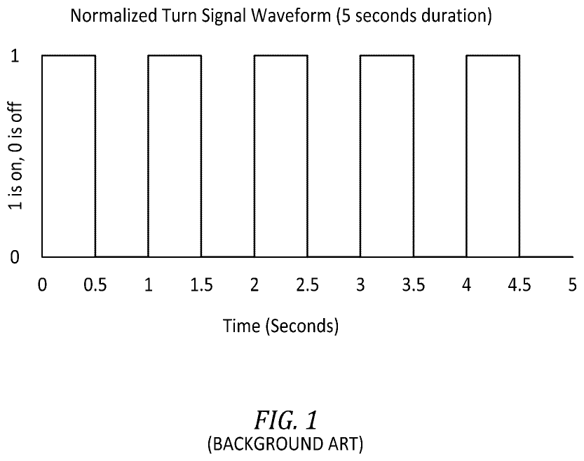

FIG. 2 is a perspective view of the U-turn signal indicator system in accordance with one embodiment of the invention.

FIG. 3 is a simplified block diagram of the controller of the system, in accordance with one embodiment of the invention.

FIG. 4 is a perspective view of the U-turn signal indicator system in operation on a vehicle, in accordance with one embodiment of the invention.

FIG. 5 is a perspective view of the U-turn signal indicator system in operation inside a vehicle, in accordance with one embodiment of the invention.

FIG. 6 is a graph illustrating an exemplary U-turn signal waveform provided by the system to the vehicle, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described throughout this document, the term “removably secured” and derivatives thereof shall be used to describe a situation wherein two or more objects are joined together in a non-permanent manner so as to allow the same objects to be repeatedly joined and separated. This can be accomplished through the use of any number of different “connectors.”

Several nonlimiting examples of connectors include but are not limited to thread-to-connect, twist-to-connect, and push-to-connect type devices, opposing strips of hook and loop material (e.g., Velcro®), attractively-oriented magnetic elements or magnetic and metallic elements, buckles, clamps, and compression fittings, for example.

As described herein, the term “permanently secured” shall be used to describe a situation wherein two or more objects are joined together in a manner so as to prevent the same objects from being separated. Several nonlimiting examples of permanent connectors include various adhesives such as glue or resin, hardware such as nuts and bolts, and welds, for example.

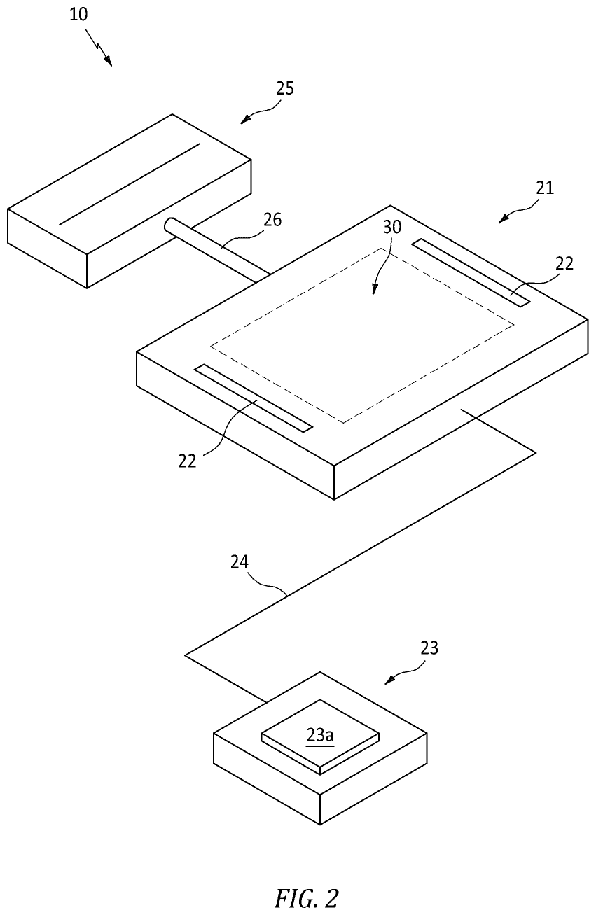

FIGS. 2-6 illustrate one embodiment of a U-Turn signal indication system 10 that is useful for understanding the inventive concepts disclosed herein. As will be described below, the system can be configured to selectively operate the turn signal indicator lights of a motor vehicle to indicate the vehicle intends to make a U-turn.

In one embodiment, the system 10 can include, essentially, a main body 21 that houses a system controller 30, a user input device 23, and a vehicle communication plug 25. As described herein, the main body 21 can include any number of different shapes and sizes and can be constructed from any number of different materials suitable for housing the system controller elements in a secure, impact dampening and watertight manner.

In one preferred embodiment, the main body can be constructed from lightweight injection molded plastic having a plurality of internal connectors for securely housing each of the controller components 31-34. Of course, any number of other known construction materials such as PVC and composites, for example, are also contemplated.

The main body can include any number of connectors 22 to allow an installer to permanently or removably position the body 21 anywhere along or within the vehicle, such as the passenger cabin or engine compartment, for example, in order to ensure the communication plug 25 is able to engage the vehicle's onboard computer system.

The user input device 23 can function to allow a user to communicate with the system controller and to selectively operate the system components. In one embodiment, the user input device 23 can include a push button 23a or other such actuator that is positioned within the housing. The device 23 can be connected to the main body 21 and controller 30 via a communication cable 24, and the device can be positioned at any desirable location, such as the vehicle dashboard, for example.

Although described above with regard to a simple push button that is connected to the controller via a cable, other embodiments are contemplated wherein the user input device 23 is wirelessly connected to the controller via an internally located transceiver, and/or wherein the device includes a display screen, such as a touch screen capable of providing two way communication between a user and the system controller.

The vehicle communication plug 25 can include any number of components capable of directly interfacing with and/or physically connecting to one or more onboard computer systems of a vehicle, such as the Controller Area Network (CAN), for example, which facilitate operation of the vehicle's turn signal indicator lights. In one embodiment, the communication plug 25 can comprise a CAN transceiver having a shape and size that is suitable for engaging the vehicle's CAN bus via a port that is typically located within the vehicle's fuse box, and/or the On-Board Diagnostics (OBD) port typically located beneath the steering wheel, for example.

In either instance, the plug 25 can provide direct two-way communication with the vehicle's CAN and/or other computer system(s) and can be physically coupled to the main body 21 and controller 30 via a power and communication cable 26. Although described with regard to a CAN transceiver, other embodiments are contemplated wherein the system utilizes one or more different types of plugs or devices for communicating with other portions of the vehicle and/or the vehicle's computer systems.

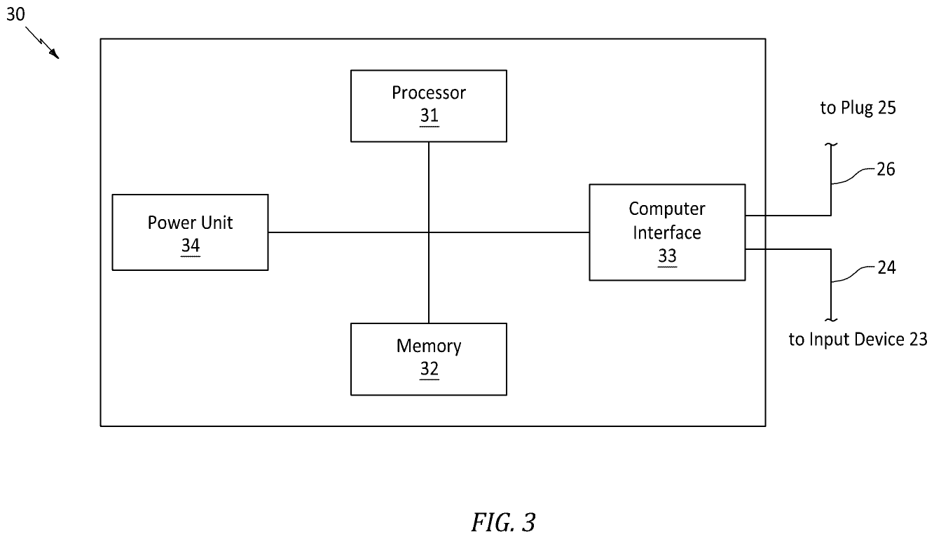

As shown at FIG. 3, the system controller 30 can include a processor 31 that is conventionally connected to an internal memory 32, a component interface unit 33, and a power unit 34.

Although illustrated as separate elements, those of skill in the art will recognize that one or more system components may comprise or include one or more printed circuit boards (PCB) containing any number of integrated circuit or circuits for completing the activities described herein. Of course, any number of other analog and/or digital components capable of performing the below described functionality can be provided in place of or in conjunction with the below described controller elements.

The processing unit 31 can be any type of central processing unit (CPU) or any other type of device, or multiple devices, capable of manipulating or processing information such as program code stored in the memory 32 and for causing the circuitry to complete the activities and functionality described herein.

The memory 32 can act to store operating instructions in the form of program code for the processor 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example, containing programs that permit the processor to perform the mode signaling methods described below. Additionally, memory 32 can also include one or more cache memories that provide temporary storage of at least some program code in order to reduce the number of times program code must be retrieved from the bulk storage device during execution. Each of these devices are well known in the art.

In one embodiment, the memory 32 can include any number of operating instructions for communicating with the CAN bus or other computer systems of a vehicle, in order to instruct the vehicle to selectively operate the turn signal indicator lights. To this end, the memory may be provided with instructions specific to a single type or brand of vehicle or may be encoded with instructions for multiple different brands or types of vehicles.

The component interface unit 33 can function to provide a communicative link between the controller 30 and various other system components such as the user input device 23 and the vehicle communication plug 25, for example. In this regard, the component interface unit can include any number of different elements such as one or more wireless transceivers, one or more PIC microcontrollers, internal buses, USB connections and other such components. Of course, any other means for providing one or two-way communication between the controller and other devices are also contemplated.

The power unit 34 can include any number of different components capable of providing the necessary power requirements to each element of the notification system. In the preferred embodiment, the system 30 will receive its operating power from the vehicle itself via the plug 25 and cable 26, to this end, the power unit can include or comprise any number of voltage and/or current regulation components for providing the necessary operating power to each component of the controller. Additionally, it is contemplated that the power unit 34 may also include one or more onboard batteries which can provide power to the controller when needed.

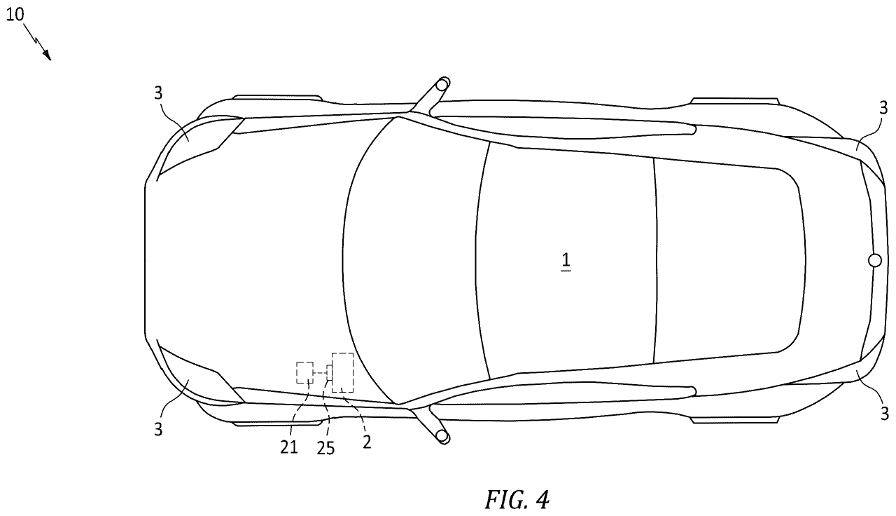

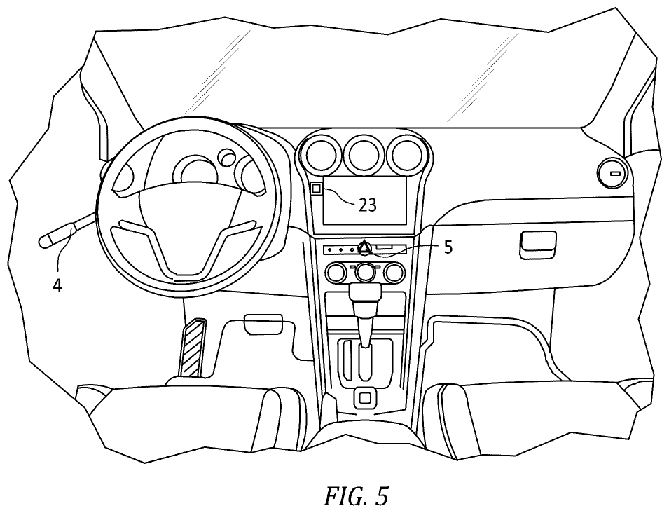

As shown at FIGS. 4 and 5, the main body 21 can be installed anywhere along or within an automobile 1, so that the plug 25 can be connected to the vehicle's CAN bus 2. When so connected, the controller can interface with the CAN bus to detect CAN messages corresponding to specific actions or settings enabled by the driver and can instruct the CAN bus to selectively operate the vehicle's turn signal indicator lights 3.

For example, upon detecting the turn-signal stalk 4 has been actuated by the driver for a specific direction (e.g., stalk up corresponds to a left hand turn, and stalk down corresponds to a right hand turn), and either the vehicles hazard button 5 or the push button of the user input device 23 has been depressed, the system controller 30 can instruct the vehicle CAN bus to operate the turn signal indicator lights 3 in a specific visual pattern that is different from the standard visual pattern the vehicle would normally make when making a left or right hand turn.

Of course, other embodiments are contemplated wherein the system 10 can be configured to selectively operate the vehicle turn signal indicator lights based on any number of other actions or settings enabled by the driver of the vehicle.

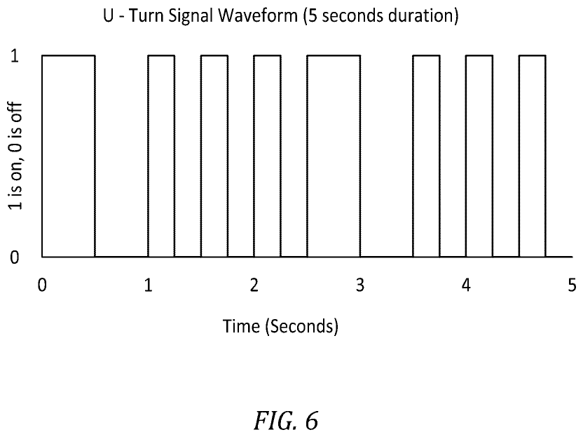

In the preferred embodiment, the specific visual pattern to which the system 10 will instruct the vehicle to perform will be a pattern that is universally or regionally recognized to indicate the vehicle is making a U-Turn. Efforts are currently underway for establishing the proposed waveform for a U-turn as an initial 1 second pulse (0.5 second active followed by 0.5 second inactive) followed by a 1.5 second Tri-active pulse (0.25 on, 0.25 off, 0.25 on, 0.25 off, 0.25 on and 0.25 off) as shown at FIG. 6. The sequence of the 1 second pulse combined with the 1.5 second pulse is repeated until the U turn is completed by the driver whereby the stalk returns to its neutral position. Of course, other patterns are contemplated.

Although described above with regard to a system for use with existing vehicles, other embodiments are contemplated. To this end, those of skill in the art will recognize that the system components may be incorporated into the new construction of a vehicle such that the controller 30 forms an integral part of the vehicle computer system and wherein the user input device is blended with the vehicle controls. In such an embodiment, it is further contemplated the system functionality could be operated via voice commands by the driver utilizing the vehicles onboard audiovisual components.

As to a further description of the manner and use of the present invention, the same should be apparent from the above description. Accordingly, no further discussion relating to the manner of usage and operation will be provided.

As described herein, one or more elements of the above noted device and system can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system comprising:
a vehicle communication unit that is configured to engage a computer system of a vehicle; and
a controller having a processor and a memory, said controller being communicatively linked to the vehicle communication unit,
wherein the controller is configured to selectively instruct the computer system of the vehicle to operate a vehicle turn signal light in a visual pattern.

2. The system of claim 1, wherein the controller is configured to detect a specific action or a specific vehicle setting enabled by a driver of the vehicle.

3. The system of claim 2, wherein the controller instructs the computer system of the vehicle to operate the turn signal light in the visual pattern in response to the detected action or setting.

4. The system of claim 1, wherein the visual pattern is provided by the controller to the computer system of the vehicle.

5. The system of claim 4, wherein the visual pattern is different from a turn signal pattern stored within the computer system of the vehicle.

6. The system of claim 1, wherein the controller is positioned within a main body enclosure.

7. The system of claim 6, wherein the main body is configured to enclose the controller in a watertight manner.

8. The system of claim 1, wherein the vehicle communication unit is physically coupled to the controller via a communication cable.

9. The system of claim 8, wherein the vehicle communication unit is configured to receive operating power from the vehicle and the communication cable is configured to deliver the operating power to the controller.

10. The system of claim 9, wherein the controller includes a power unit that is configured to regulate and distribute the operating power from the communication cable to each of the processor and the memory.
